(19) United States
(12) Patent Application Publication
(10) Pub. No.: US 2014/0041054 A1
(43) Pub. Date: Feb. 6, 2014

(54) ATTESTATION OF POSSESSION OF MEDIA CONTENT ITEMS USING FINGERPRINTS

(71) Applicants: Mine Yalcinalp, Seattle, WA (US); Vincent Bannister, Redmond, WA (US); Jeffrey Abraham, Seattle, WA (US)

(72) Inventors: Mine Yalcinalp, Seattle, WA (US); Vincent Bannister, Redmond, WA (US); Jeffrey Abraham, Seattle, WA (US)

(73) Assignee: MICROSOFT CORPORATION, Redmond, WA (US)

(21) Appl. No.: 13/564,232

(22) Filed: Aug. 1, 2012

(51) Int. Cl. G06F 21/00

(52) U.S. Cl. 726/28; 726/30

(57) ABSTRACT

A method for verifying a user's access to a content media item includes discovering at least one content item stored on a storage medium associated with a client device. A fingerprint of a selected portion of the media content item is obtained. The selected portion is a portion less than an entirety of the media content item. The fingerprint is communicated to an online service. Access to an online copy of the media content item is received if the fingerprint matches a known fingerprint of a media content item available to the online service.

### BACKGROUND

A variety of media content music delivery applications and services have been deployed across a wide variety of platforms to cater to different needs. In particular, online marketplaces have become popular which allow users to play and organize digital music and video files stored on a user's desktop computer, or other suitable electronic device. Many of these types of digital media applications also enable users to purchase and download media content such as music, music videos, television shows, applications, games, audio-books, various podcasts and films. The above-mentioned applications and services generally enable users to organize and catalogue media content stored on their various electronic devices.

Some of the above-mentioned applications and services allow users to maintain their media content online (in the “cloud”). However this generally only applies to media content purchased through their service or, alternatively, to media content that the user uploads to the service. Both of these approaches are limited; they generally require you to buy music from their service or pay someone for the online storage space needed to maintain their personal collection of media content items.

### BRIEF DESCRIPTION OF THE DRAWINGS

FIG. 1 shows an illustrative computing environment in which access to media content can be provided to a subscribing user on multiple client devices.

FIG. 2 shows a functional block diagram of one example of a content manager server.

FIG. 3 shows an example of data stored in association with a typical user account.

FIG. 4 shows a functional block diagram of one example of a client media application 400 that may be employed by a client device.

FIG. 5 shows a message flow diagram of one example of a media content matching process.

FIG. 6 shows one example of a mobile device.

### SUMMARY

In some implementations a client program or application is provided which periodically scans a user's media library for new media content. In some embodiments the client program may be integrated into a media player. Alternatively, the client program may be a free-standing program or part of another program. For each newly discovered content item, the client program calls a cloud service and provides it with metadata associated with the content item. The service responds with a request for one or more fingerprints of the content item. The request specifies the portion or segment of the content item that is to be fingerprinted, typically by specifying one or more offsets denoting the start time of the requested sample within the content item. The request may also specify the duration of the sample in some cases.

For each requested fingerprint, the client program may decode the requested segment of the content item and then either compute the fingerprint itself or sends the decoded content to the service which computes the fingerprint. In other implementations the client program may send the undecoded segment of the content item to the service, which can then decode it itself. Once the service has obtained the requested fingerprint(s) it compares it against a known set of valid fingerprints for all media. The known set of fingerprints may be selected based on the metadata initially presented by the client program. In this way the service does not have to compare the fingerprint(s) against all the known fingerprints available to it.

If the fingerprints provided match a known fingerprint of a content item available to the service, the service may provide the client with a secured token which can be used by any of the user's client devices to make a call to a cloud collection service to unlock that particular content item. In this way the user can access the content item from a myriad of different devices without ever having uploaded the entire content item to the service. In some implementations once the content has been unlocked or otherwise made available by the user's client device that sent the fingerprint(s), the content is unlocked or otherwise made available by other client devices associated with the user. In yet other implementations the client device that receives the token may pass it to other client devices associated with the user. The other client devices receiving the token may then use it to unlock or otherwise make the content available. Of course, other mechanisms may be employed to make the content items available to all the client devices associated with the user.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### DETAILED DESCRIPTION

As used herein, the term “media content” is used to describe different types of digital media (or “content”) including but not limited to digital audio, digital video, software, games, documents etc. over a delivery medium such as the Internet. For purposes of illustration and not as a limitation on the subject matter described herein, the following discussion will occasionally refer specifically to musical content. However, more generally, the subject matter described herein is applicable to other types of media content and is not limited to musical content.

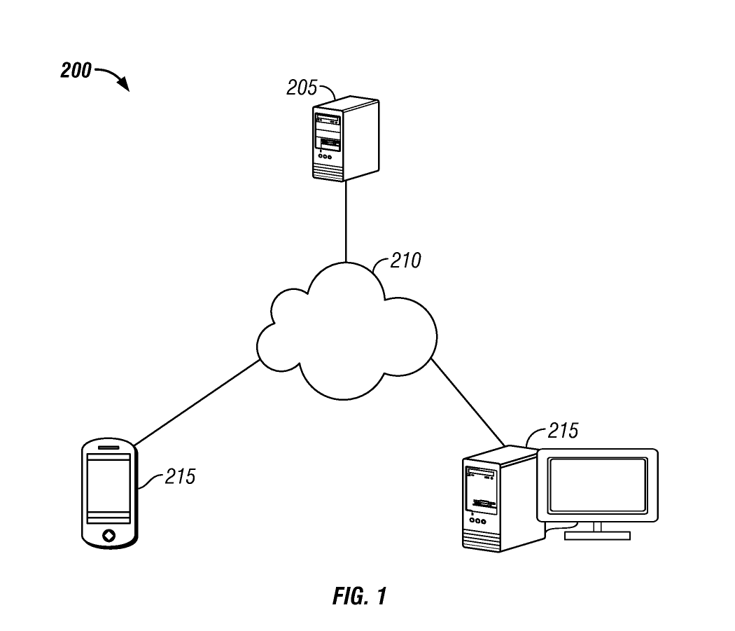

FIG. 1 shows an illustrative computing environment 200 in which access to media content can be provided to a subscribing user on multiple client devices. Content manager server 205 can be implemented using a single computing device or multiple computing devices, which can be co-located or distributed across two or more locations. For instance, in some implementations, server 205 can be implemented using one or more application servers, web servers, and/or data servers.

Content manager server 205 can host one or more applications configured to manage the content of subscribing users. For instance, server 205 can be configured to validate a user before the user is authorized to perform application and/or media related functions, including storing and downloading media content from server 205. Further, server 205 can maintain an instance of one or more user accounts, including user account details, e.g. mobile identification number and subscriber name, a list of available content and so on. Additionally, server 205 can be configured to manage the transfer of media content to one or more subscribing users, including the transfer of media requested by a particular user to a particular client device and the automated transfer of music associated with subscribed play lists.

Content manager server 205 can be adapted to communicate with subscribing users over a network 210, which can be implemented using one or more data networks. For instance, network 210 can include either of both of wired and wireless communication links. Further, network 210 can be a public network, e.g. the Internet, a private network, e.g. a cellular data network, or a combination thereof. Network 210 also can include one or more gateways, which facilitate the transfer of data between devices using different protocols. Network 210 also can include either or both of secure links and unsecure links. Additionally, network 210 can include network infrastructure provided by multiple parties, such as a host network and one or more partner networks, e.g. roaming partners.

One or more client devices 215 associated with subscribing users also can be configured to communicate over network 210, e.g. with server 105. Any number of client devices 215 can be included in computing environment 200. As the number of mobile communications devices 215 increases, server 205 and network 210 can be scaled, e.g. by adding additional resources, to provide an acceptable level of service. For purposes of illustration only, FIG. 1 shows two client devices 215 and a single server 205. Client devices 215 may be any devices that can communicate over network 210. For example, client devices 215 may be, without limitation, a PC, laptop, netbook, tablet, television, gaming device, landline or wireless telephone, smart phone, media device or a dedicated appliance.

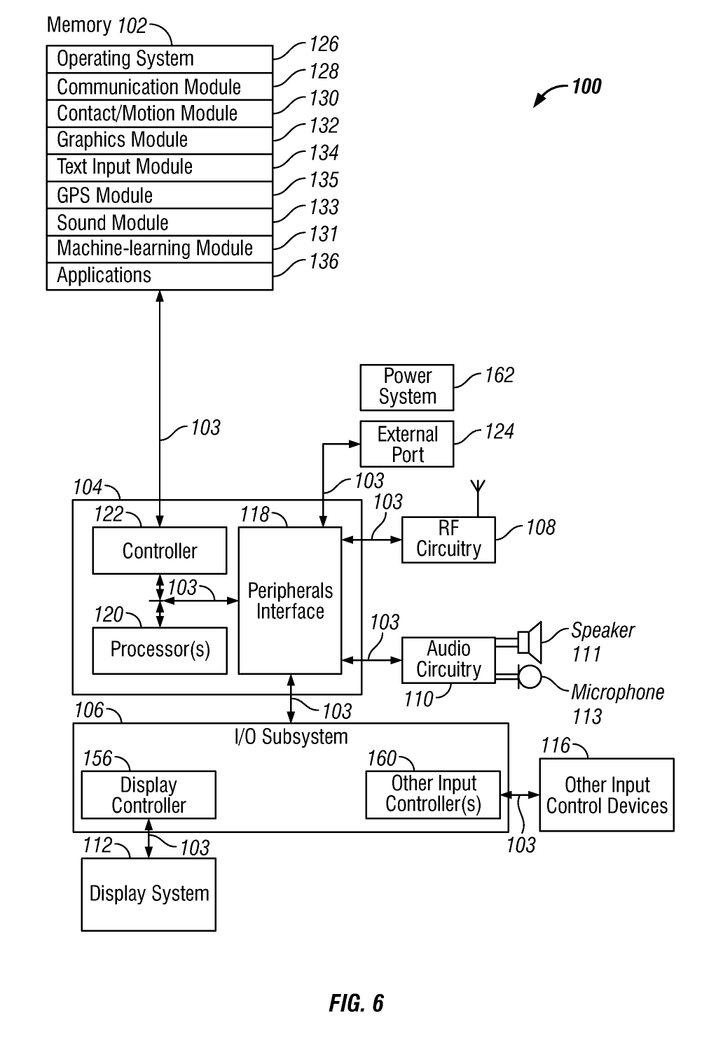

If client devices 215 are mobile communications devices such as wireless phones, in some cases they may also contain other functions, such as PDA and/or music player functions. To that end the device may support any of a variety of applications, such as a telephone application, a video conferencing application, an e-mail application, an instant messaging application, a blogging application, a digital camera application, a digital video camera application, a web browsing application, a digital music player application, and/or a digital video player application. In some implementations the client device 215 may correspond to a mobile device of the type that will be described below in connection with FIG. 6.

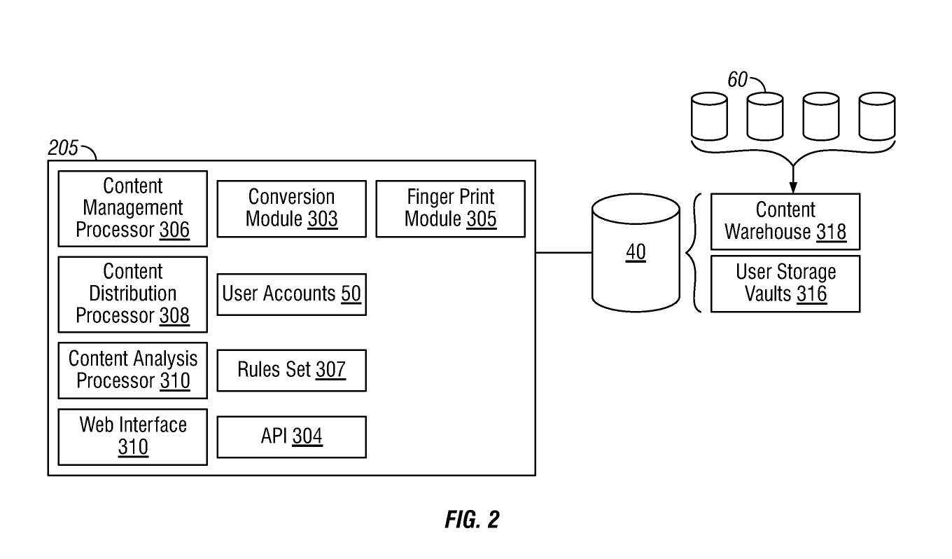

FIG. 2 shows a functional block diagram of one example of a content manager server 205 in more detail. The content management server 205 includes: a plurality of user accounts 50; a web interface 302; an application programming interface (API) 304; a content management processor 306; a content distribution processor 108; a content analysis processor 310; and at least one data storage device 40. In one implementation each user account 50 may be associated with corresponding content in the content warehouse 318 as well as a user storage vault 316, both of which are provided in this example on storage device 40. Content from the storage 40 is configurable to be streamed, downloaded, and/or otherwise made available in real-time to one or more client devices. Storage 40 may include a music content warehouse 318. The music content warehouse 318 provides an online destination for housing all commercially available content, whereas content unique to a user is typically held in the user vault area 316. The content management server 205 may also include a conversion module 303 operable to convert content into different formats suitable for different types of devices.

It should be noted that in some implementations one or more of the functions performed by the content management server 205 may be alternatively performed by a client-side application. One example of such an application will be discussed below.

The web interface 310 provides front-end access to the content management server 205 via a web browser interface. General technologies for such web-based user interfaces are well known in the art for accepting various user inputs, and provide output by generating web pages which are transmitted via the Internet and viewed by the user using a web browser program such as Microsoft Internet Explorer® or other desktop or mobile browser programs well known in the art.

According to embodiments of the present invention, the web interface 302 has at least two functions: firstly, to provide normal web content such as web-pages accessible through web browsers on client devices (e.g., client 215 in FIG. 1); and secondly, to receive content from and transmit content to client devices by a suitable protocol such as HTTP, FTP or otherwise. Typically, a client device connects to the content management server 205, either through a conventional web browser or through client software residing on the client device.

The application programming interface (API) 304 is operable to integrate the content management server 205 with existing media applications such as iTunes, Winamp and Windows® Media Player such that devices running these applications and services can connect to the content management server 205 and integrate with its services. Thus, the content management server 205 can “see” the content of any connected device supported by its API. Likewise, the content analysis processor, discussed below can probe the content residing on client devices.

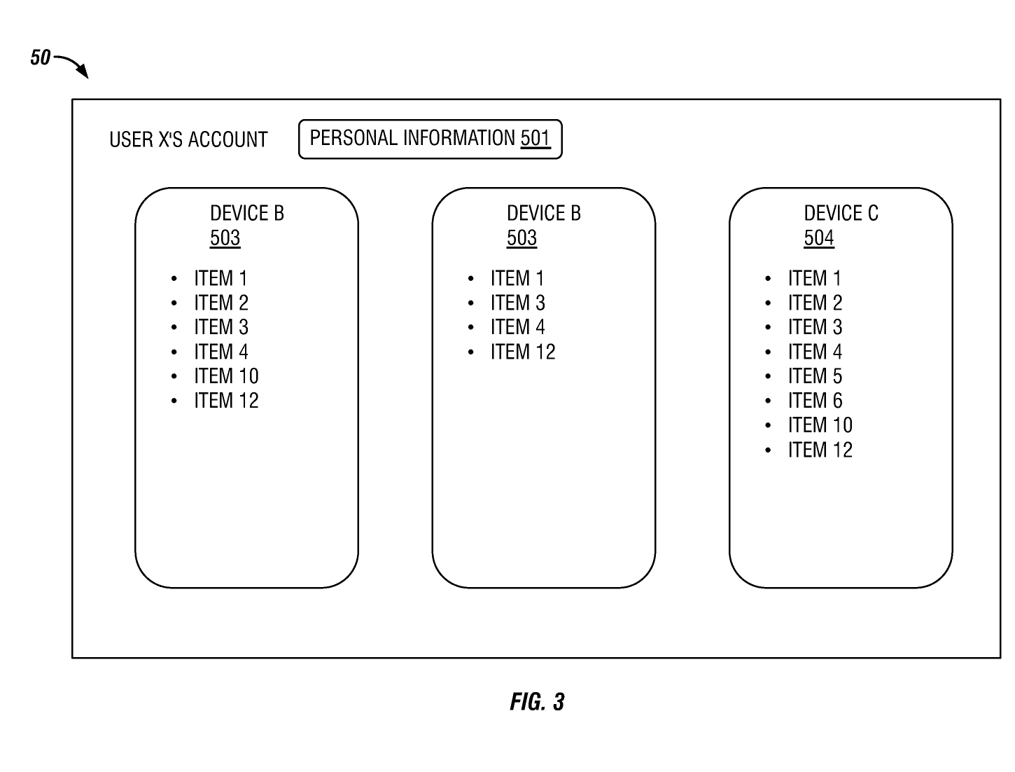

The content management server 205 comprises a suite of user accounts 50 set up for holding information gathered using known techniques e.g. filling in a registration form via the internet. Each user account 50 may have a collection map representing the particular user's entire music content collection, and possibly also how that music content is spread across individual ones of the user's client devices. The collection map may be generated upon on initial registration when the server 205 processes the user's music content collection by probing the user's various devices and is described hereinafter with reference to FIG. 3. The collection map may be periodically updated thereafter as the user adds additional musical content to one or more of the client devices. Thus the complete map, including all relevant devices, may be constructed over time. Each user account may also have an associated user storage area in user vault 316

The server 205 may thus store a record of music content held by a subscribing user. This online collection map is a representation of a user's entire music collection. Where user content listed in the collection map is recognized as commercially available content, the map merely includes a reference to the relevant content item in the content warehouse 318. In this way, users can also freely access all of their recognized content from any client device by logging into their user account 50 and requesting the content. In this context, a user's collection map may include “recognized” and “unrecognized” content, where “unrecognized” refers to non-public content and/or a user's self-generated content. Unrecognized content may be stored in the user's personal storage vault 316. For example, the user may have recordings of their own songs, videos etc. that they wish to upload to their user storage vault 316. Unrecognized content may also refer to content devoid of metadata, for instance, music tracks without artist/title information stored on the client device and which cannot be matched using a fingerprinting technique as described below. Once this content has been uploaded to user storage vault 316, the user can freely access their own content from any client device by logging into their user account 50 and requesting the content.

Hence, according to embodiments of the invention, users are able to store all of their media content in a single place online and are able to download or stream content to any device (commercial restrictions permitting).

Continuing with reference to FIG. 2, the content management server 205 also comprises a fingerprinting module 305 implementing for example commercial audio and video fingerprinting technologies. Fingerprinting is a process of identification in which a copy of a media content item is recognized as being the same as the original or a reference content item (e.g., a content item available from warehouse 318). Fingerprinting, which examines intrinsic properties of the media content and is independent of format, is a known technology which can analyze sample entire content files or portions thereof. The fingerprinting process generally involves performing a mathematical transform on the content to obtain a spectrogram. Spectral peaks in the spectrogram can be selected for comparison against known fingerprints. The fingerprinting module is configured to verify that music content items within an individual user's collection are indeed proper content files (i.e., the actual audio video or other files they appear to be from the metadata) and/or determine whether or not each content item is authentic.

The fingerprinting module 305 typically processes a user's collection on initial registration with the server 205 but also processes changes to the collection as content items are added, particularly where tracks are added other than through the retail module. In some implementations fingerprinting is performed on the entirety of a content item (e.g., a song or other musical selection). However, this can be a computationally complex and unnecessary process. Accordingly, in some processes only a portion of media content item may be fingerprinted. In some implementations the portion of the media content item that is fingerprinted may be the same for all content items. For instance, in a simple example the first e.g., 30 seconds of each content item may be fingerprinted. However, this approach can allow individuals to circumvent the validation process by obtaining only the portion of the content items that needs to be fingerprinted and then using the validation process to improperly gain access to the entire content item.

In some implementations circumvention of the validation process can be avoided by fingerprinting only a portion of the content item that appears from the user's perspective to have been selected at random. For instance, the fingerprinting module 305 can specify that the fingerprinting process is to begin at some offset (e.g., 1 minute 52 seconds) from the beginning of the content item. The offset may be specified, for instance, by a time interval defined by a start time index and an end time index or a start time index and a total duration. In some case the fingerprinting module may randomly select the time indices from a predetermined series of time indices. In some implementations fingerprints from two or more time intervals may be required.

It should be noted that the calculation of a fingerprint may be performed by the content management server 205, a third party or by the client application (discussed below). However, the selection of the time interval to be fingerprinted and the process of matching the fingerprint to the fingerprints of media content available in storage 40 will generally be performed by the content management server 205 or the third party.

According to one embodiment, the content warehouse 318 may be populated, at least in part, by an external system and/or service, for instance, through web interface 302, API 304 or other suitable interface. For example, the content warehouse 318 may receive content from or link to another supplier database or a plurality of databases. In one embodiment the content warehouse is connected to remote databases administered by media publishers, such as record labels and film studios. Referring again to FIG. 2, the optional databases 60 in this example represent the remote content databases of several record labels. However, it will be clear to the skilled person that any number of external databases from any type of content distributor may be used to populate the music content warehouse 318.

The content management processor 306 is operable to manage individual music content collections across a plurality of devices belonging to the relevant individual. It can access a set of rules 307 defining how content can be managed over the different devices of each user. A portion of the rule set 107 may be configurable by the user, for example via a collection management GUI, and a portion of the rule set 307 is configurable by an administrator. The term “administrator” herein is intended to include human administrators and/or computers. In certain embodiments, the rules 307 are at least in part defined by other software components of the system, such as the content analysis processor 310 which can set up smart synchronization rules by device according to the analysis of music consumption.

FIG. 3 shows an example of data stored in association with a typical user account 50. According to this example, X's user account comprises a unique account ID. It also includes personal information 501 such as username, password, address, age and other related data. In addition, X's user account further comprises device content listing information 502-504. Device content listing information, typically in the form of a metadata list as mentioned above, is a list of the user's content items by client device. This record (also referred to herein as “collection map”) reflects the status at the last synchronization by the content management server 205 with one or more user client devices, unless the collection has since been organized manually via the collection management interface.

Between synchronizations, the user may add new content items to any one of the user's client devices, remove content items from any one of the user's client devices and or move content items between any two of the user's client devices. All such changes in the collection will be captured during the next synchronization process, and the collection map will be updated accordingly.

Following the example shown in FIG. 3, for instance, device A could be user X's laptop, device B could be user X's media player and device C could be user X's mobile phone. Each of the items (item 1, item 2, etc.) represents individual items of content such as mp3 files, videos and such like. Often times, a content item designed to be played is available on the local memory of the device then available to the user. Where this is not the case, it can be moved there on-demand or ahead of time based on the synchronization feature or a configurable transfer schedule. In one embodiment, one or more content items can be removed to an end user device according to one or more playlists associated with that device. The online content management server 205 can thus be used to organize and distribute media content between a user's various client devices from anywhere a communication link can be established with the server.

In use, when a client device connects to the content management server 205 via the web interface 302 (or API 304), the content management processor 306 registers the device content with the content distribution processor 308. The result of this registration is a map of the user's entire collection by device, as illustrated above with reference to FIG. 3. In some embodiments, the registration process, which involves scanning or probing the content on the client devices, may be facilitated with client-based software, which will be discussed below.

According to one example, content items themselves are not transmitted to the content management server 205. Instead, one or more items of metadata indicating content items stored on client device 20 are transmitted to the content management server 205 and the content items themselves are sourced from elsewhere when they are required, e.g. the storage device 40, or an external data store, when requested by the user. For example, if a user has media item “X” on a first device (say a music track on a mobile phone) it may not be desirable to transmit a copy of the file itself for bandwidth usage or rights management reasons. Instead, a set of metadata describing commercially available tracks held on the first client device is generated by a web-based application and associated with the user's account 50. In this case, the content management processor 306 can deploy a client fingerprinting application (or engage one already residing on a user's client device) in order to check authenticity of the user's collection each time new music content items are detected.

Thereafter, if the same user logs into their account from a second client device (such as a laptop computer), which does not contain media item “X”, a copy of that item can be sourced from the storage device 40 and transmitted to the second client device. In this way content items belonging to a particular user can be legitimately distributed (by download and/or streaming) among devices owned by that user. Various automatic synchronizations may be defined at least in part within the rules 307.

Because a user's collection map only includes a reference to relevant commercially available content, the same content may be referenced in the collection maps of multiple users. According to this feature, if content being recorded or manipulated already exists in the datastore 40, the content management processor 306 can create a reference file to the existing content, rather than generating multiple copies of the content item. Hence, only a single instance of unique content need to be stored on the content management server 205, meaning that storage resources and bandwidth usage can be kept to a minimum. Therefore, no matter how many unique users add the same content item to their collection, the content management server 205 is able to distribute the content item from the same source.

According to one embodiment, when a user device connects to the content management server 205 via web interface 302 and/or API 304, the user's existing collection stored on the user device 20 is ‘synchronized’ with the same user's online account 50. Hence, any content items present on device(s) 20 that do not already appear in the user's collection map (see FIG. 3) may be may be matched against content in content warehouse 318. If a match is found, fingerprinting is performed to validate that the content is in fact locally accessible to the user. Once validated, the content is registered in the user's online account, listed in the user's collection map and made available for the user to access on any client device. In this way, the content management server can facilitate the movement of content into the online collection map and from there between different devices belonging to the user. This can be automatic according to the system rules or automatic according to user configurations, as well as a direct response to the user's organization through the collection management interface.

In some embodiments, the content management processor 306 also synchronizes content stored on the user's individual client devices which is unknown or unavailable to the content management server with content registered in the collection map. According to one example, when a connection from a client device is established or detected, the content management processor 306 automatically synchronizes content in the user storage vault 316 with unknown content in the internal memory of the client device. The system may allow the user to override automatic synchronization. In any event, synchronization of unknown content involves transferring content (and/or metadata describing the content) out of the memory of the client device 20 into the user storage vault 316, transferring content (and/or metadata describing the content) from the user storage vault 316 to the internal memory of the user device 20, or a combination of the two.

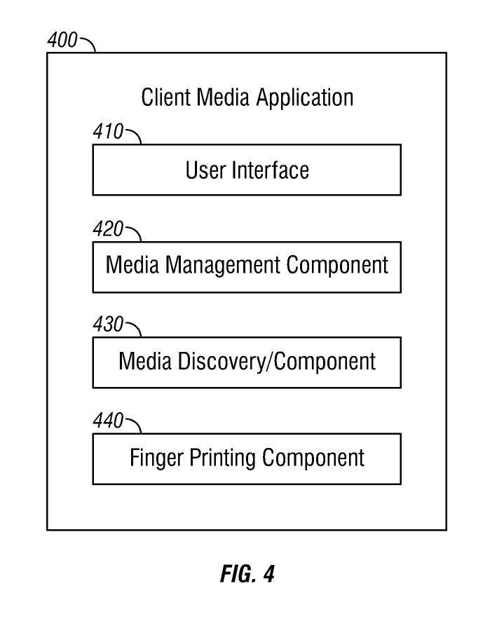

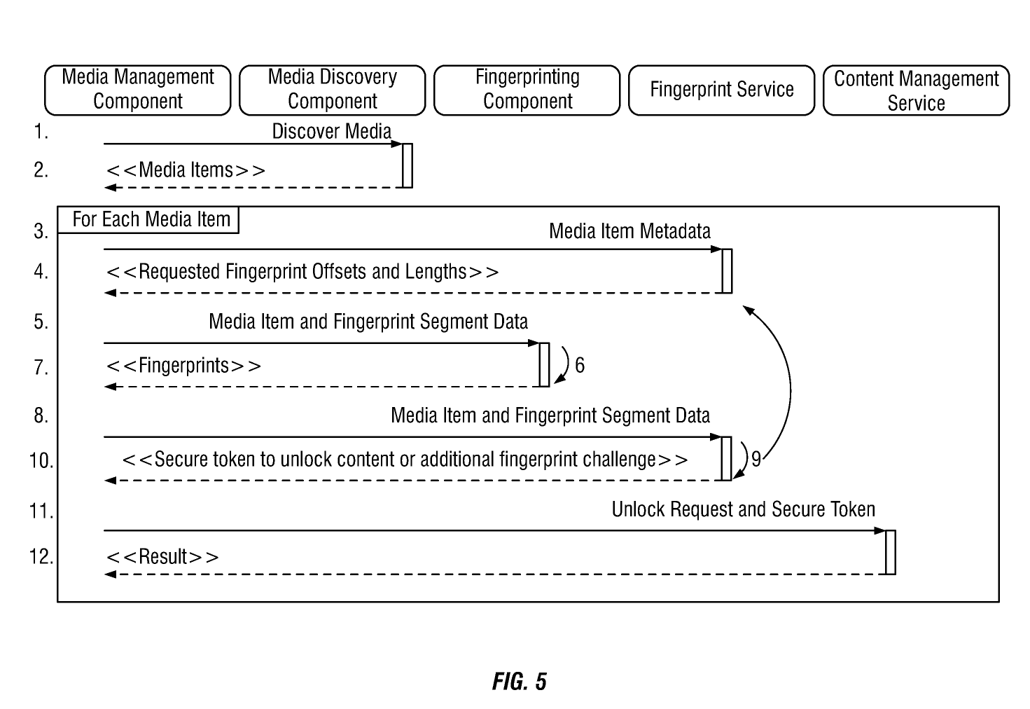

FIG. 4 shows a functional block diagram of one example of a client media application 400 that may be employed by a client device (e.g., client devices 215 in FIG. 1). The client media application 400 in this example includes user interface 410, media management component 420, media discovery component 430 and fingerprinting component 440. While in this example the functions of media discovery and media content fingerprinting are performed by the client media application, as previously mentioned, in other implementations one or both of these functions may be performed by the content manager server. One example of a media content matching process which employs the client media application of FIG. 4 is shown in the message flow diagram of FIG. 5.

FIG. 5 shows the flow of messages between the components of the client media application, the fingerprint service and the content management service. While in this example the fingerprint service and content management service are illustrated as distinct services, in some implementations these services may be integrated and offered as parts of a single service.

Beginning at 1, the media management component sends a media discovery request to the media discovery component. This request may be sent on some periodic basis, on boot-up, whenever the client management application is executed, and/or when new media content is loaded onto a client device. Next, at 2, the media discovery component requests that the media management component send it the metadata for newly discovered media content items. Such metadata may include any suitable information facilitating identification of the content items such as a title, performer, composer, album and so on.

After requesting the metadata at 2, messages 3-12 are performed for each of the newly discovered content items. These messages may be sent sequentially for each content item or concurrently for all the newly discovered items. Moreover, in some cases individual messages may be sent for multiple content items. At 3, the media management component sends the metadata for the content items to the fingerprint service. In response, at 4 the fingerprint service sends the media management component the offsets or time indices which specify the intervals within the content items that are to be fingerprinted.

At 5, the media management component decodes the media content item(s) to be fingerprinted and sends it and the associated offsets or time indices to the fingerprinting component. The fingerprinting component calculates the fingerprint(s) at 6 and returns them to the media management component at 7. As previously mentioned, fingerprinting techniques may use commercial technologies to analyze the media content item(s) or portions thereof to verify that content items are in the individual user's collection and are authentic. At 8, the media management component sends the fingerprint(s) and associated metadata, which is used as an identifier of the fingerprints, to the fingerprint service. The fingerprint service compares the fingerprints against a store of pre-computed known fingerprints at 9. The store of known fingerprints includes a series of fingerprints for media content items available to the content management service. The number of known fingerprints to which an unknown fingerprint is compared can be substantially reduced through the use of the metadata. If a match is found, the fingerprint service concludes that the user of the client device possesses a valid copy of the content items that has been identified. The fingerprint service then sends the client device at 10 a secure token or other item which serves to demonstrate or otherwise indicate that the user is in possession of the content items and is entitled to access them from the content management service. The client device stores the token and at 11 sends it to the content management service whenever the user wishes to access the content item on one of his or hers client devices. Upon receiving the token the content item is made available for downloading and/or streaming to the client device at 12.

If at 9 a match is not found between a fingerprint of a user's content item and known fingerprints to which it has been compared, the search may be expanded to examine fingerprints that were not previously examined during the initial matching process. This may be useful, for instance, when some or all of the metadata associated with the content item which was provided by the user is inaccurate, thereby leading to an erroneous set of known fingerprints initially being selected for comparison.

If the fingerprinting service and the content management service are integrated, the need for a token or the like may be eliminated. In this case, once it has been determined that the user of the client device possesses a valid copy of a content item, the content management service can automatically unlock or otherwise made that content item available to the user. Likewise, even if the fingerprinting service and the content management service are provided as separate services, the fingerprinting service may make a call to the content management service on behalf of the user informing the service that the content item may be unlocked, once again avoiding the need for a user token.

In some implementations it may be desirable for the fingerprinting service to request additional fingerprints of a content item after examining the initial set of fingerprints it received. This may be particularly desirable, for instance, when there are multiple versions of a media item available and selection of the correct version requires a more refined match. For example, some content items may have explicit and non-explicit versions or studio and live versions which need to be distinguished from one another. Additional fingerprints may also be desirable if the fingerprints of the initially selected segment of the content item happen to be publically available.

In some implementations the client devices 215 of FIG. 1 may correspond to a mobile device of the type that will be described below in connection with FIG. 6.

The mobile device 100 in FIG. 6 includes a memory unit 102 (which may include one or more computer readable storage media), a memory controller 122, one or more processors (CPU's) 120, a peripherals interface 118, RF circuitry 108, audio circuitry 110, a speaker 111, a microphone 113, display system 112, an input/output (I/O) subsystem 106, other input or control devices 116, and an external port 124. These components may communicate over one or more communication buses or signal lines 103. Along with the input or control devices 116, the speaker 111, microphone 113 and display system 112 form a user interface through which a user can enter and receive various types of information and can communicate with other individuals over communication networks using RF circuitry 108.

It should be appreciated that the device 100 is only one example of a mobile communications device 100 and that the device 100 may have more or fewer components than shown, may combine two or more components, or a may have a different configuration or arrangement of components. The various components shown in FIG. 2 may be implemented in hardware, software or a combination of both hardware and software, including one or more signal processing and/or application specific integrated circuits.

Memory unit 102 may include high-speed random access memory and non-volatile memory, such as one or more magnetic disk storage devices, flash memory devices, or other non-volatile solid-state memory devices. Access to memory unit 102 by other components of the device 100, such as the processor 120 and the peripherals interface 118, may be controlled by the memory controller 122. The peripherals interface 118 couples the input and output peripherals of the device to the processor 120 and memory unit 102. The one or more processors 120 run or execute various software programs and/or sets of instructions stored in memory unit 102 to perform various functions for the device 100 and to process data. In some examples the peripherals interface 118, the processor 120, and the memory controller 122 may be implemented on a single chip, such as a chip 104. In other examples they may be implemented on separate chips.

The RF (radio frequency) circuitry 108 includes one or more receivers and transmitters (e.g., a transceivers) for respectively receiving and sending RF signals, also called electromagnetic signals over both the WLAN 250 and the mobile communication network 240. The RF circuitry 108 converts electrical signals to/from electromagnetic signals and communicates with communications networks and other communications devices via the electromagnetic signals. The RF circuitry 108 may include well-known circuitry for performing these functions, including but not limited to an antenna system, an RF transceiver, one or more amplifiers, a tuner, one or more oscillators, a digital signal processor, a CODEC chipset, a subscriber identity module (SIM) card, memory, and so forth. The RF circuitry 108 communicates with mobile communications networks and WLANs such as shown in FIG. 1.

The audio circuitry 110, the speaker 111, and the microphone 113 form a part of the user interface provide an audio interface between a user and the device 100. The audio circuitry 110 receives audio data from the peripherals interface 118, converts the audio data to an electrical signal, and transmits the electrical signal to the speaker 111. The speaker 111 converts the electrical signal to human-audible sound waves. The audio circuitry 110 also receives electrical signals converted by the microphone 113 from audible signals (i.e., sound waves). The speaker 111 and microphone 113 are two examples of audio transducers that may be employed in the mobile communications device. The audio circuitry 110 converts the electrical signal to audio data and transmits the audio data to the peripherals interface 118 for processing. Audio data may be retrieved from and/or transmitted to memory unit 102 and/or the RF circuitry 108 by the peripherals interface 118. In some embodiments, the audio circuitry 110 also includes a headset jack (not shown). The headset jack provides an interface between the audio circuitry 110 and removable audio input/output peripherals, such as output-only headphones or a headset with both output (e.g., a headphone for one or both ears) and input (e.g., a microphone).

The I/O subsystem 106 couples input/output peripherals on the device 100, such as the display screen 112 and other input/control devices 116, to the peripherals interface 118. The I/O subsystem 106 may include a display controller 156 and one or more input controllers 160 for other input or control devices. The one or more input controllers 160 receive/send electrical signals from/to other input or control devices 116. The other input/control devices 116 may include physical buttons (e.g., push buttons, rocker buttons, etc.), dials, slider switches, joysticks, click wheels, and so forth. In some examples input controller(s) 160 may be coupled to any (or none) of the following: a keyboard, infrared port, USB port, and a pointer device such as a mouse.

In some implementations the various input devices may support natural user interface (NUI) methods. Examples of NUI methods include those relying on speech recognition, touch and stylus recognition, gesture recognition both on screen and adjacent to the screen, air gestures, head and eye tracking, voice and speech, vision, touch, gestures, and machine intelligence. Specific categories of NUI technologies include touch sensitive displays, voice and speech recognition, intention and goal understanding, motion gesture detection using depth cameras (such as stereoscopic camera systems, infrared camera systems, rgb camera systems and combinations of these), motion gesture detection using accelerometers/gyroscopes, facial recognition, 3D displays, head, eye, and gaze tracking, immersive augmented reality and virtual reality systems, all of which provide a more natural interface, as well as technologies for sensing brain activity using electric field sensing electrodes (EEG and related methods).

The display screen 112 provides an input interface and an output interface between the device and a user. The display controller 156 receives and/or sends electrical signals from/to the display screen 112. The display screen 112 displays visual output to the user. The visual output may include graphics, text, icons, video, and any combination thereof (collectively termed “graphics”).

The display screen 112 will generally include a suitable display such as an OLED display, PLED display, active matrix liquid crystal display, passive matrix liquid crystal display, electrophoretic display, cholesteric liquid crystal display, polymer dispersed liquid crystal and nematic liquid crystal display. In some implementations the display screen 112 may be a touch-screen display.

The device 100 also includes a power system 162 for powering the various components. The power system 162 may include a portable power supply (e.g., battery) and components used to receive power from an alternating current (AC) source, a power management system, a recharging system, a power failure detection circuit, a power converter or inverter and any other components associated with the generation, management and distribution of power in portable devices.

In some embodiments, the software components stored in memory unit 102 may include an operating system 126, a communication module (or set of instructions) 128, a contact/motion module (or set of instructions) 130, a graphics module (or set of instructions) 132, a text input module (or set of instructions) 134, a Global Positioning System (GPS) module (or set of instructions) 135, a sound module 133 (or set of instructions) and applications (or set of instructions) 136.

The operating system 126 (e.g., Darwin, RTXC, LINUX, UNIX, OS X, Microsoft WINDOWS®, Android or an embedded operating system such as VxWorks) includes various software components and/or drivers for controlling and managing general system tasks (e.g., memory management, storage device control, power management, etc.) and facilitates communication between various hardware and software components. The communication module 128 facilitates communication with other devices over one or more external ports 124 and also includes various software components for handling data received by the RF circuitry 108 and/or the external port 124 (e.g., Universal Serial Bus (USB), FIREWIRE, etc.).

The graphics module 132 includes various known software components for rendering and displaying graphics on the display screen 112, including components for changing the intensity of graphics that are displayed. As used herein, the term “graphics” includes any object that can be displayed to a user, including without limitation text, web pages, icons (such as user-interface objects including soft keys), digital images, videos, animations and the like. The text input module 134, which may be a component of graphics module 132, provides soft keyboards for entering text in various applications (e.g., contacts 137, e-mail 140, IM 141, blogging 142, browser 147, and any other application that needs text input).

The GPS module 135 determines the location of the device and provides this information for use in various applications (e.g., applications that provide location-based services such as weather widgets, local yellow page widgets, and map/navigation widgets).

The applications 136 may include any combination of the following illustrative modules: a contacts module, a telephone module; a video conferencing module; an e-mail client module an instant messaging (IM) module; a blogging module; a camera module; an image management module; a video player module; a music player module; a browser module; a word processing module; a voice recognition module; a calendar module; widget modules, which may include a weather widget, stocks widget, calculator widget, alarm clock widget, dictionary widget, and other widgets obtained by the user, as well as user-created widgets. In one implementation, applications 136 may include a client media application such as shown in FIG. 4.

Each of the above identified modules and applications correspond to a set of instructions for performing one or more functions described above. These modules (i.e., sets of instructions) need not be implemented as separate software programs, procedures or modules, and thus various subsets of these modules may be combined or otherwise re-arranged in various embodiments. In some embodiments, memory unit 102 may store a subset of the modules and data structures identified above. Furthermore, memory unit 102 may store additional modules and data structures not described above. For instance, in the illustrative environment of FIG. 1, client devices 220 or 230 may be used to place and receive calls and messages on mobile device 215 using the WLAN 250 to establish communication between the two devices. In one particular implementation, this functionality is implemented on the mobile device side by an application such as the aforementioned remote access application.

The disclosed methods, apparatus, and systems should not be construed as limiting in any way. Instead, the present disclosure is directed toward all novel and nonobvious features and aspects of the various disclosed embodiments, alone and in various combinations and subcombinations with one another. The disclosed methods, apparatus, and systems are not limited to any specific aspect or feature or combination thereof, nor do the disclosed embodiments require that any one or more specific advantages be present or problems be solved. The techniques and solutions described in this application can be used in various combinations to provide an improved user experience with mobile devices, including mobile devices such as smart phones.

Any of the methods described herein can be performed via one or more computer-readable media (e.g., storage or other tangible media) comprising (e.g., having or storing) computer-executable instructions for performing (e.g., causing a computing device to perform) such methods. Operation can be fully automatic, semi-automatic, or involve manual intervention.

Having described and illustrated the principles of our innovations in the detailed description and accompanying drawings, it will be recognized that the various embodiments can be modified in arrangement and detail without departing from such principles. For example, any technologies described herein for capturing still photos can also be adapted for capturing video. It should be understood that the programs, processes, or methods described herein are not related or limited to any particular type of computing environment, unless indicated otherwise. Various types of general purpose or specialized computing environments may be used with or perform operations in accordance with the teachings described herein. Elements of embodiments shown in software may be implemented in hardware and vice versa.

In view of the many possible embodiments to which the principles of the disclosed invention may be applied, it should be recognized that the illustrated embodiments are only preferred examples of the invention and should not be taken as limiting the scope of the invention. Rather, the scope of the invention is defined by the following claims. We therefore claim as our invention all that comes within the scope of these claims and their equivalents.

1. A method for verifying a user's access to a content media item, comprising:
discovering at least one content item stored on a storage medium associated with a client device;
obtaining a fingerprint of a selected portion of the media content item, the selected portion being a portion less than an entirety of the media content item;
communicating the fingerprint to an online service; and
receiving access to an online copy of the media content item if the fingerprint matches a known fingerprint of a media content item available to the online service.

2. The method of claim 1 further comprising receiving access to the media content item on any of a plurality of different client devices.

3. The method of claim 1 further comprising:
receiving a token from the online service indicating that a user is in possession of a valid copy of the media content item;
communicating the token to a second online service to obtain access to the online copy of the media content item.

4. The method of claim 1 further comprising sending metadata associated with the at least one media content item to the online service.

5. The method of claim 1 in which the media content item includes a musical content item.

6. The method of claim 1 further comprising receiving an offset specifying the selected portion of the media content item that is to be fingerprinted.

7. The method of claim 1 further comprising receiving a start and stop time identifying the selected portion of the media content item that is to be fingerprinted.

8. The method of claim 1 further comprising receiving a first request to obtain and communicate a first fingerprint of the selected portion of the media content item and, after communicating the first fingerprint, receiving a second request to obtain and communicate a second fingerprint of a second portion of the media content item different from the selected portion of the media content item.

9. One or more computer-readable storage media containing instructions which, when executed by one or more processors, perform a method comprising:
obtaining a fingerprint of a selected portion of at least one media content item stored on a storage medium associated with a client device used by a user;
comparing the fingerprint to a set of known fingerprints of media content items available for delivery to client devices over a communications network;
identifying a match between the fingerprint and a first of the known fingerprints of a first of the media content items; and
causing a content management service to provide the user with access to an online copy of the first media content item on any of a plurality of client devices associated with the user.

10. The computer-readable storage media of claim 9 further comprising discovering at least one content item stored on the storage medium associated with the client device associated with a user.

11. The computer-readable storage media of claim 10 in which discovery of the at least one content item includes receiving from the user metadata associated with the at least one content item.

12. The computer-readable storage media of claim 9 further comprising sending to the user a first offset specifying a first selected portion of the media content item that is to be fingerprinted to obtain a first fingerprint.

13. The computer-readable storage media of claim 9 in which obtaining the first fingerprint includes receiving the fingerprint from the client device.

14. The computer-readable storage media of claim 12 further comprising randomly selecting the first offset from a set of offsets that each specify a selected portion of the media content for which a known fingerprint is available.

15. The computer-readable storage media of claim 14 further comprising sending to the user one or more additional offsets specifying one or more additional portions of the media content item that is to be fingerprinted to obtain one or more additional fingerprints.

16. The computer-readable storage media of claim 15 in which sending the one or more additional offsets to the user is performed subsequent to comparing the first fingerprint to known fingerprints.

17. The computer-readable storage media of claim 9 in which the comparing and the identifying are performed by the content management service.

18. The computer-readable storage media of claim 9 in which causing the content management service to provide the user with access to the online copy includes sending a token to the client device over a communications network indicating that a user is in possession of a valid copy of the media content item, said token being configured to unlock the online copy when received by the content management service to thereby provide the user with access to the online copy.

19. A mobile communication device, comprising:
one or more wireless transmitters and receivers for communicating over a wireless communication network;
one or more processors for executing machine-executable instructions;
one or more machine-readable storage media for storing the machine-executable instructions, the instructions, when executed by a processor, cause the processor to perform acts comprising:
scanning the one or more machine-readable storage media for new media content items;
providing metadata associated with new media content items discovered during scanning;
receiving one or more offsets specifying a portion of each of the new media content items that is to be fingerprinted;
fingerprinting the specified portions of the new media content items to obtain fingerprints of the new media content items;
transmitting the fingerprints over a communications network to a content management service; and
in response to transmitting the fingerprints, receiving access to an online copy of the new media content items.

20. The mobile communication device of claim 19 further comprising:
receiving a token indicating that a user is in possession of a valid copy of the media content items;
communicating the token to a second online service to obtain access to the online copy of the media content items.
